(19) United States
(12) Patent Application Publication
(10) Pub. No.: US 2010/0181028 A1
(43) Pub. Date: Jul. 22, 2010

(54) INTEGRALLY-FORMED CONTAMINATION-RESISTANT ADHESIVE TAPE DISPENSER

(76) Inventor: CHI-TSAI CHANG, Taichung City (TW)

Correspondence Address: LEONG C LEI, PMB # 1008, 1867 YGNACIO VALLEY ROAD, WALNUT CREEK, CA, 94598, US

(21) Appl. No.: 12/684,959

(22) Filed: Jan. 10, 2010

(30) Foreign Application Priority Data
Jan. 19, 2009 (TW) 098200972

(51) Int. Cl. B32B 38/04

(52) U.S. Cl. 156/510

(57) ABSTRACT

An integrally-formed contamination-resistant adhesive tape dispenser includes an integrally-formed injection-molded dispenser body, which has a curvedly recessed tape dispensing mouth and a cover that are connected to each other in an integrated and rotatable manner to provide a frame- or box-like stable and stiff configuration. Two side plates form in lower sides of central sections thereof symmetric folding lines to allow for outward bending of half portion of the two sides. Opposite central portions on inside surfaces of the bendable side plates are provided with projecting shaft cylinders that engage each other to allow for a body of adhesive tape to fit thereon, so that the projecting shaft cylinders of the side plates can mate and couple to each other to form a complete structure of the adhesive tape dispenser, which allows the dispenser to be molded with a single mold and suits the needs for safe and sanitary operations.

### TECHNICAL FIELD OF THE INVENTION

The present invention generally relates to an integrally-formed contamination-resistant adhesive tape dispenser, wherein the adhesive tape dispenser is simply formed in an integrally formed manner with a single mold so that tape-dispensing curvedly recessed mouth edges are interconnected with side plates and a cutting blade to show, as a whole, a U-shape, providing the cutting mouth with stiffness and stability, and a cover for shielding and covering purposes is integrally formed therewith in a pivotable manner, and the two side plates form, in a symmetric manner, folding lines on a lower side of a central section thereof to allow the side plates to be bendable in opposite directions, whereby these components are molded in a single mold, making the molding and modularized manufacturing of the adhesive tape dispenser easy and the manufacturing costs lowered, and being convenient for a user to simply bending sideways the side plates for replacement of adhesive tapes, and the whole assembly of the adhesive tape dispenser being set in a completely enclosed form to suit the needs for sanitary and practicability

### DESCRIPTION OF THE PRIOR ART

A regular small-sized adhesive tape dispenser, especially a portable adhesive tape dispenser, is constructed as shown in FIG. 4 of the attached drawings, wherein the adhesive tape dispenser comprises a body 21 that is formed by integrally connecting thin sheet like side plates 22 that are usually formed of thin sheet like material and are connected together at a central section thereof by a flat board 23 in such a way that allow for bending of the components to form a U-shaped configuration. The flat board 23 forms a positioning surface and the flat board 23 has an end forming a toothed cutter blade 24 integrated therewith. The opposing central sections of the side plates 22 respectively form projecting halves of a combinable axle 25 that is formed by fitting counterpart projection and recess to each other to receive a body of adhesive tape 20 to directly fit thereon so as a center for rotation. A leading end of the adhesive tape 20, after being unwound and withdrawn, is cut off by the cutter blade 24. Since the body 21 of the adhesive tape dispenser shows a side-open configuration and curvedly recessed cutting mouth edges that are provided for the purposes of cutting off the adhesive tape are also of an open arrangement, the adhesive tape 20, after being loaded, is not in a completely enclosed condition and is thus easily susceptible to external contamination or staining with contaminants and this does not suit the needs of sanitary applications thereof. This is particularly true for medical purposes for there is more concern about sanitary operation and application of adhesive tapes. Further, the cutting mouth edges are exposed and it is easy to cause undesired contact, leading to operation safety regarding hurting users and damaging the cutter. For the consideration of sanitary and safe operation in practical uses, the existing portable adhesive tape dispensers require further improvement in view of the above problems.

### SUMMARY OF THE INVENTION

In view of the problem that the existing simplified adhesive tape dispenser does not suit the needs for safe and sanitary operations, the present invention aims to provide an integrally-formed contamination-resistant adhesive tape dispenser, which uses a stiffly fixed arrangement of a frame- or box-like configuration in a cutting mouth of a dispenser body, together with opposite folding lines that are pre-formed in portions of two side plates adjacent to lower sides of the cutting mouth, so as to provide an assembled arrangement that allows for outward bending and projecting cylinders are formed on inside surfaces of the side plates for easy fitting of adhesive tape thereon for loading, whereby, after properly assembled, the adhesive tape is completely enclosed and the cutting mouth edges are rotatably coupled to a cover for properly shielding and covering the cutting mouth to thus provide a completely enclosed arrangement of adhesive tape dispenser that ensures safe and sanitary use and operation of the adhesive tape and completely eliminate the drawbacks of the existing adhesive tape dispensers that do not suit the needs for safe and sanitary operations.

The primary objective of the present invention is to provide a design of adhesive tape dispenser, of which the whole structure is formed in an integrally formed manner with a single mold, so that assembling can be done for subsequent use without the needs for putting separate parts together and effective and complete enclosure of adhesive tape and cutting mouth can be realized to make the structure of adhesive tape dispenser simple and easy to mold and safe and sanitary applications are realized.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an adhesive tape dispenser according to the present invention in an expanded form.

FIG. 2 is a perspective view of an adhesive tape dispenser according to the present invention in an assembled form.

FIG. 3 is a perspective view of the adhesive tape dispenser according to the present invention taken from an opposite side.

FIG. 4 is a perspective view showing a conventional hand-held simplified adhesive tape dispenser.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

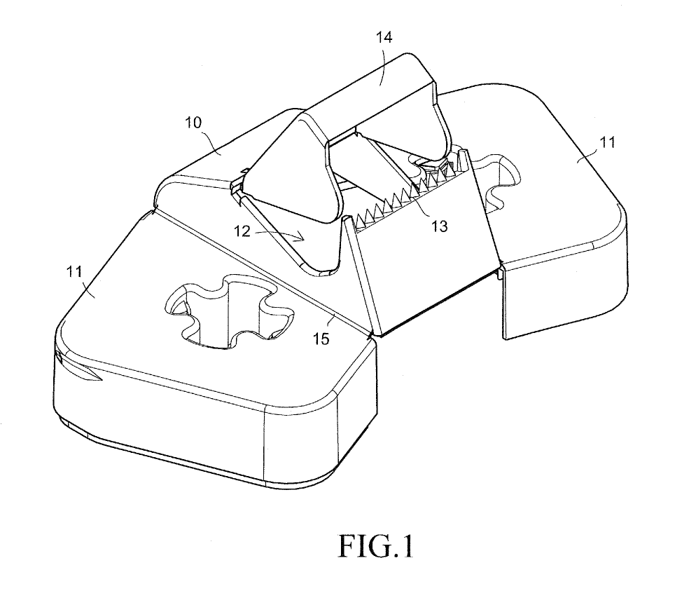

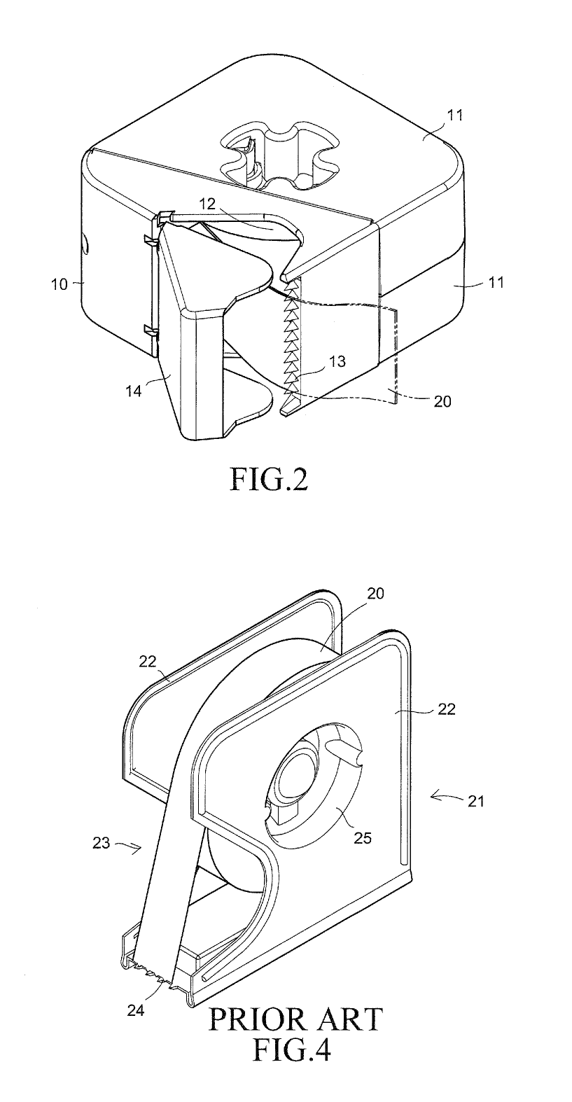

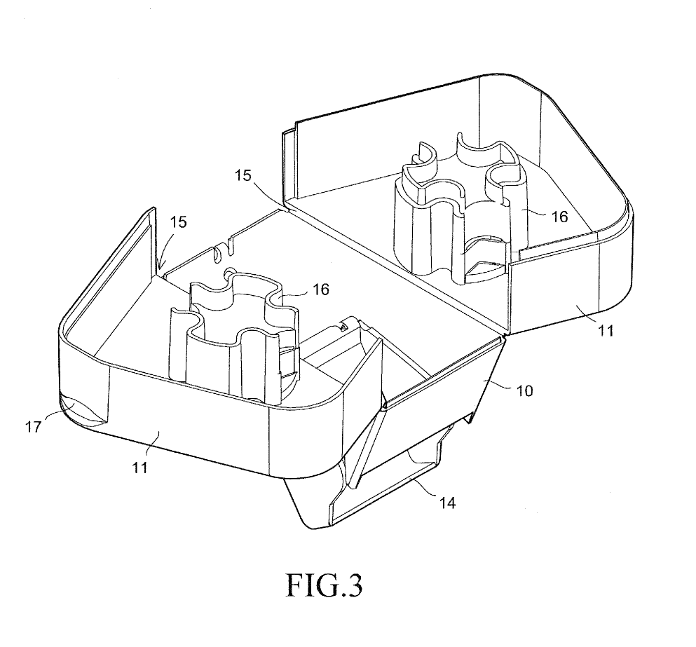

The present invention provides an integrally-formed contamination-resistant adhesive tape dispenser of which the whole structure is designed to provide an improvement that exhibits the features of easy formation and simplified assembling of adhesive tape dispenser and safe and convenient use. The whole structure of the adhesive tape dispenser of the present invention will be described with reference to FIGS. 1-3. The formation of a body 10 of the whole adhesive tape dispenser is performed with a single mould in an integrally formed manner in a single-step operation. A major feature is placed in the arrangement of a cutting mouth of the adhesive tape dispenser to accommodate the need of maintaining structural stiffness in an actually molded product so as to provide a practical efficacy of safe and convenient operation of tape cutting in actually carrying out tape cutting operations, wherein opposite side plates 11, curvedly recessed mouth edges 12, a cutting blade 13, and a cover 14 that is rotatably mounted for selective closing operation are all formed in a U-shaped box-like enclosure for integral formation. Portions of the side plates 11, which are close to bottoms of the curvedly recessed cutting mouth edges 12, are provided with folding lines 15 that are opposite to each other so as to allow the side plates 11 to respectively fold outward. Central portions of the side plates respectively form oppositely projecting halves of shaft-like mutually-coupleable cylinders 16, whereby after the two side plates 11 are placed facing each other and thus coupled to each other, the cylinders 16 are jointed to each other for receiving a body 20 of adhesive tape to fit thereon and allowing the adhesive tape to wind thereon. The two side plates 11 may alternatively be of a non-symmetrical arrangement, wherein the cylinder 16 and surrounding panel portions are formed only on one side surface and opposite side surfaces are then fit to and coupled to each other. Tops of the curvedly recessed cutting mount edges 12 formed on the body 10 forms, in an integral form, a projecting serrated cutting blade 13 for cutting purposes, whereby when the adhesive tape 20 is unwound and pulled outward through the curvedly recessed cutting mouth, a simple operation of cutting can be easily performed. In the molding of the cutting edge, the sharpened edge can be set to gradually thinned in a direction from the bottom to the edge so as to realize a design of sharpness for effort-saved and neat cutting. The whole body of adhesive tape 20 is effectively and completely enclosed and a cover 14 is further provided for completely covering and closing, in a proper manner, the cutting edge portion of the cutting blade 13 for complete protection of the adhesive tape and realizing contamination resistance and security maintenance against damage of the cutting edge, so that practical efficacies of operation sanitary and storage safety of the adhesive tape dispenser are ensured.

In the design of formation structure of adhesive tape dispenser according to the present invention, the whole body 10 is molded in an integrally formed manner, and particularly, the cutting blade 13, the curvedly recessed mouth edges 12, and the two side plates 11 are integrally connected and molded in a frame-like configuration, whereby after the molding and formation, the positioning of the cutting edge and structural stiffness of the cutting blade 13 can be constructed in a secured and retained manner due to the inter-connected arrangement provided by the two side surfaces. The most prominent effect is that after a length of adhesive tape has been pulled out and a cutting operation is carried out, due to the rigid arrangement for the cutting position of the cutting blade 13, characteristics of simple and neat cutting can be obtained. This, together with the feature that a major portion of each of the side plates 11 is bendable, a practical efficacy of simplifying an fitting and assembling operation of a body of adhesive tape 20 to the dispenser can be obtained. The bending operation of the side plate 11 can be done with the assistance of a recessed operation face 17 that is properly provided in advance in an edge portion of the surface of the plate in the molding thereof, as shown, so as to simplify the operation of separation of the two plates to really satisfy the practical need for simply and easily loading the body of adhesive tape 20. The whole structure can be made with a single mold in a single step of injection molding and folding and formation can be immediately carried out without any additional operation of putting parts together after de-molding and this makes the present invention a novel structure of adhesive tape dispenser that offers extremely practical uses and also meets the needs of lowering the manufacturing costs to the lowest level. In view of the structural features of the adhesive tape dispenser that completely encloses the body of adhesive tape 20 and the cover 14 covering outside the cutting edge, efficacies of safety and positioning by completely and reliably enclosing and covering, so that the whole structure of the adhesive tape dispenser is of integral completeness and offers novel features of completeness and aesthetics of outside appearance of adhesive tape dispenser and also provides practical efficacies of safe storage, sanitary, and simplification, totally meeting the requirements of structural simplification manufacturing economics. The completely enclosed, sanitary, and stable configuration of the present invention is novel in view of the currently existing products.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An integrally-formed contamination-resistant adhesive tape dispenser, comprising two side plates, curvedly recessed cutting mouth edges, and shaft cylinders that are centrally located for receiving a body of adhesive tape to fit thereon, characterized in that the two side plates, the curvedly recessed mouth edges through which the adhesive tape is pulled outward, and a cutting blade for cutting of the adhesive tape, and a cove that is liftable for opening are interconnected and integrally formed in a frame-like retained structure, the side plates forming in bottom portions of the curvedly recessed cutting mouth edge folding lines opposite to each other to allow the side plates to bend outward, central portions of side plates forming the cylinders for forming a shaft, whereby the adhesive tape is allowed to manufacture with a single mold in an integrally formed manner in a single-step operation, the two side plates being coupleable to each other to enclose the body of adhesive tape to provide an adhesive tape dispenser having a completely enclosing arrangement.

2. The integrally-formed contamination-resistant adhesive tape dispenser according to claim 1, wherein the side plates form, in an edge of a surface thereof a recessed operation face to facilitate operation of separation of the side plates.

3. The integrally-formed contamination-resistant adhesive tape dispenser according to claim 1, wherein the two side plates have inside surfaces that are of unsymmetrical structures.
